(19) United States
(12) Patent Application Publication
(10) Pub. No.: US 2011/0282580 A1
(43) Pub. Date: Nov. 17, 2011

(54) METHOD OF IMAGE BASED NAVIGATION FOR PRECISION GUIDANCE AND LANDING

(75) Inventor: Srinivasan Mohan, Bangalore (IN)

(73) Assignee: HONEYWELL INTERNATIONAL INC., Morristown, NJ (US)

(21) Appl. No.: 12/777,467

(22) Filed: May 11, 2010

(51) Int. Cl. G06F 19/00; G01S 19/40; G06F 17/30; G01C 21/00

(52) U.S. Cl. 701/216; 701/207; 701/213; 707/802; 707/E17.044

(57) ABSTRACT

A method to improve landing capability for an aircraft is provided. The method includes storing calibrated-offline-reference images of at least one runway in the aircraft and capturing real-time images of a destination runway during an approach to the destination runway. The destination runway is one of the at least one runway. The method further includes comparing the real-time images of the destination runway with the calibrated-offline-reference images of the destination runway to select respective closest calibrated-offline-reference images from the calibrated-offline-reference images for the associated real-time images; evaluating translational differences and rotational differences between associated real-time images and selected closest calibrated-offline-reference images; and determining errors in translational coordinates and rotational coordinates provided by a navigation system in the aircraft during the approach based on the evaluated translational differences and rotational differences.

### BACKGROUND

When commercial aircraft land in airports, at night and in foggy conditions, situational awareness and precision landing can be difficult. In some airports there may not be sufficient lighting for the runways and there may be no air traffic controller. With the help of enhanced vision systems, the problem with situational awareness in commercial aircraft has been reduced to a great extent. However, precision landing is still an issue without some ground equipment available at airport runways, such as instrument landing system (ILS), ground base augmentation system (GBAS), etc. The onboard inertial navigation system/global positioning system (INS/GPS) of commercial aircraft is not accurate enough to be used for landing without ground based equipment.

Hence, the ground based landing systems are still a necessity for precisely landing the aircraft. However the ground based landing systems are costlier to build and maintain. The rural airports in remote areas may not have the money to build and maintain such equipment. Additionally, ground based landing systems may not be suitable for all kinds of airports like airports with less traffic and airport at remote location and used rarely.

### SUMMARY

The present application relates to a method to improve landing capability for an aircraft. The method includes storing calibrated-offline-reference images of at least one runway in the aircraft and capturing real-time images of a destination runway during an approach to the destination runway. The destination runway is one of the at least one runway. The method further includes comparing the real-time images of the destination runway with the calibrated-offline-reference images of the destination runway to select respective closest calibrated-offline-reference images from the calibrated-offline-reference images for the associated real-time images; evaluating translational differences and rotational differences between associated real-time images and selected closest calibrated-offline-reference images; and determining errors in translational coordinates and rotational coordinates provided by a navigation system in the aircraft during the approach based on the evaluated translational differences and rotational differences.

### DRAWINGS

FIGS. 1A and 1C show an embodiment of a calibration system 48 collecting images of a runway from different geographic locations during a calibration process in accordance with the present invention;

FIG. 1B shows an orientation of a hovercraft coordinate system superimposed on the runway coordinate system;

FIGS. 2A and 2B show geographic locations of calibration points from which a calibrated set of the offline-reference images are collected during a calibration process in accordance with the present invention;

FIG. 2C shows an oblique view of the runway of FIGS. 2A and 2B and an extent of the region in which calibration points are required;

FIG. 3 is an embodiment of a system to improve landing capability for an aircraft in accordance with the present invention;

FIG. 4 is an embodiment of a system to improve landing capability for an aircraft in accordance with the present invention;

FIG. 5A shows a three-dimensional representation of aircraft during an approach to a destination runway in accordance with the present invention;

FIG. 5B shows a three-dimensional representation of the aircraft of FIG. 5A at a different time during the approach to a destination runway in accordance with the present invention;

FIG. 6 is a flow diagram of one embodiment of a method to generate a calibrated set of the offline-reference images in accordance with the present invention;

FIG. 7 is a flow diagram of one embodiment of a method to improve landing capability for an aircraft in accordance with the present invention; and

FIG. 8 is a flow diagram of one embodiment of a method to improve landing capability for an aircraft in accordance with the present invention.

In accordance with common practice, the various described features are not drawn to scale but are drawn to emphasize features relevant to the present invention. Like reference characters denote like elements throughout figures and text.

### DETAILED DESCRIPTION

The present application describes embodiments of a method and system to solve the above referenced problem of landing without ground-based equipment. Specifically, the methods and systems described herein are useful when there are no ground-based instruments and/or when the runway is obscured or dark. Additionally, the methods and systems described herein are useful even in airports with ground-based landing systems, since onboard INS/GPS are not accurate enough for precision landing without aid provided by ground-based instruments and there may be times when the communication link between the landing aircraft and the ground based system is lost. In such a loss of communication, the methods and system described are implemented to improve the precision of the landing by sending error corrections to the onboard INS/GPS.

The method includes a calibration process during which a calibration system is used to generate calibrated sets of offline-reference images for runways at which the aircraft is likely to be landing at some time in the future. The calibration process is done once for each runway requiring a calibrated set of the offline-reference images. The set of images for a runway can include up to 100 images. When the aircraft is scheduled to land at a destination runway, the calibrated set of the offline-reference images for that destination runway and associated translation/rotation coordinates is loaded, along with the flight plan, into the aircraft. In one implementation of this embodiment, a calibrated set of offline-reference images for at least one alternative runway is also loaded into the aircraft. An alternative runway is a runway that is likely to be used if the aircraft is not able to land at the destination runway for some unexpected reason. The “calibrated-offline-reference image” is also referred to herein as a “calibrated image.” Likewise, features from the calibrated-offline-reference image are referred to herein as “calibrated features.” The “set of calibrated-offline-reference images” is also referred to herein as the “calibrated set of offline-reference images.”

During an approach to the destination (or alternative) runway, real-time images received from a real-time camera (forward looking infrared (FLIR) or stereo) are provided to aircraft onboard instruments and compared against the calibrated set of offline-reference images. Based on the comparison, corrections are provided to onboard INS/GPS navigation system. Real-time images of the destination runway are images captured by a real-time camera on the aircraft during an approach for landing at the destination runway.

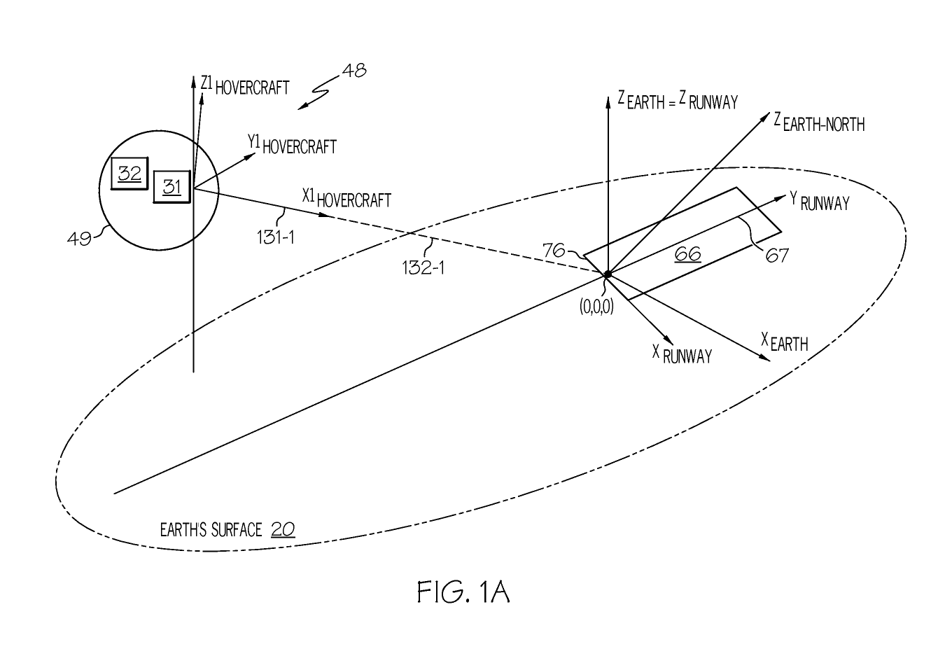

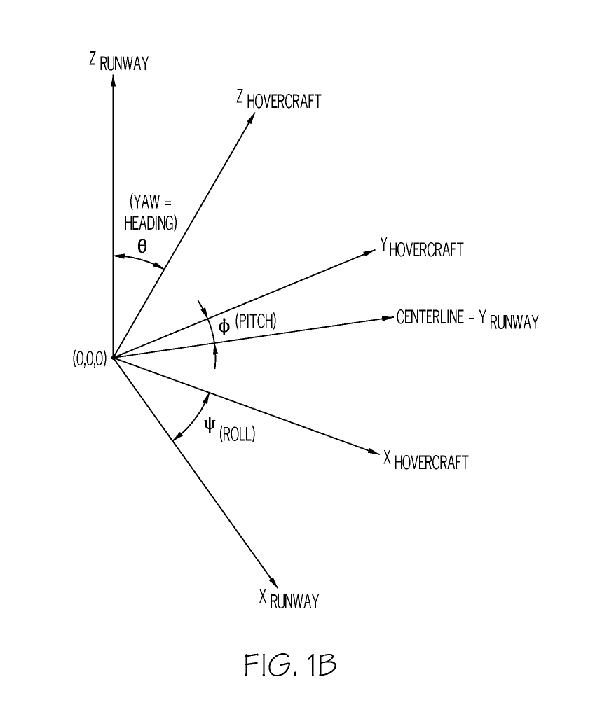

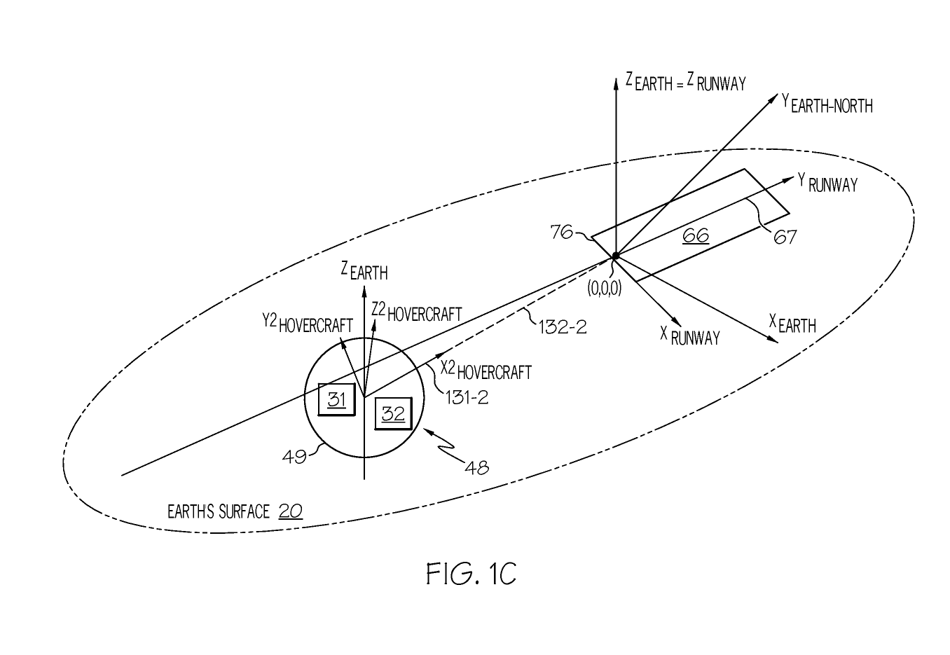

FIGS. 1A and 1C show an embodiment of a calibration system 48 collecting images of a runway 66 from different locations (x_{hovercraft}, y_{hovercraft}, z_{hovercraft}) during a calibration process in accordance with the present invention. FIG. 1B shows the orientation of a hovercraft coordinate system (x_{hovercraft}, y_{hovercraft}, z_{hovercraft}) superimposed on the runway coordinate system (x_{runway}, y_{runway}, z_{runway}). Typically, the hovercraft coordinate system (x_{hovercraft}, y_{hovercraft}, z_{hovercraft}) is correlated to the body frame of the hovercraft. Specifically, the orientation angles (ψ, φ, θ) indicative of roll, pitch, and yaw, respectively, of the hovercraft 49 is shown in FIG. 1B. The calibration system 48 collects calibrated sets of offline-reference images of the runways and collects known geographic locations and known orientations of the aircraft for the calibrated sets of the offline-reference images. The calibration system 48 includes a hovercraft 49 in which a calibration camera 70 and a navigation system 32 are located.

In FIG. 1A, the hovercraft 49 is in a first known location (x1_{hovercraft}, y1_{hovercraft}, z1_{hovercraft}) and in a first known orientation 131-1 (also referred to herein as vector 131-1) that is approximately aligned to and overlapping a first connecting line 132-1 that extends between the origin of the hovercraft 49 (x1_{hovercraft}=0, y1_{hovercraft}=0, z1_{hovercraft}=0) and the runway axes origin (x_{runway}=0, y_{runway}=0, z_{runway}=0). The origin (0, 0, 0), which is also referred to herein as the runway axes origin (x_{runway}=0, y_{runway}=0, z_{runway}=0), is defined as a known geographic location (latitude0_{runway}, longitude0_{runway}, altitude0_{runway}) on the runway 66. The know locations are also referred to herein as “known geographic locations” represented as (latitude_{hovercraft}, longitude_{hovercraft}, altitude_{hovercraft}). Thus, the first known geographic location (x1_{hovercraft}, y1_{hovercraft}, z1_{hovercraft}) is (latitude1_{hovercraft}, longitude1_{hovercraft}, altitude1_{hovercraft}).

In FIG. 1C, the hovercraft 49 is in a second known geographic location (x2_{hovercraft}, y2_{hovercraft}, z2_{hovercraft}) (e.g., (latitude2_{hovercraft}, longitude2_{hovercraft}, altitude2_{hovercraft})) and has a second known orientation 131-2 that is aligned to and approximately overlapping a second connecting line 132-2 that extends between the origin of the hovercraft 49 (x1_{hovercraft}=0, y1_{hovercraft}=0, z1_{hovercraft}=0) and the runway axes origin (x_{runway}=0, y_{runway}=0, z_{runway}=0). In one implementation of this embodiment, the hovercraft 40 is moved from the first known geographic location (latitude1_{hovercraft}, longitude1_{hovercraft}, altitude1_{hovercraft}) to the second known geographic location (latitude2_{hovercraft}, longitude2_{hovercraft}, altitude2_{hovercraft}), which is separated from the first known geographic location by less than 500 meters in a latitudinal direction, by less than 500 meters in a longitudinal direction, and by less than 500 meters in a vertical (altitudinal) direction. In another implementation of this embodiment, the hovercraft 40 is moved from the first known geographic location to the second known geographic location which is separated from the first known geographic location by less than a few hundred meters in a latitudinal direction, by less than a few hundred meters in a longitudinal direction, and by less than a few hundred meters in a vertical direction.

Hovercraft 49 is capable of hovering in a specific known location (x_{hovercraft}, y_{hovercraft}, z_{hovercraft}) above the earth's surface 20. In one implementation of this embodiment, the hovercraft 49 is a helicopter. The navigation system 32 includes a global positioning system receiver, and an inertial navigation system that includes gyroscopes and accelerometers, which provide an integrated INS/GPS output. The navigation system 32 is configured to measure the location and orientation of the hovercraft 49. The global positioning system receiver provides information indicative of the geographic location of the hovercraft 49. The GPS, camera and other sensors have a known lever arm between these sensors and the origin of the hovercraft axes (x1_{hovercraft}=0, y1_{hovercraft}=0, z1_{hovercraft}=0). The GPS, camera and other sensors are compensated, based on the lever arm.

Thus, during the calibration process, the position (latitude_{hovercraft}, longitude hovercraft, altitude_{hovercraft}) of the hovercraft 49 and the orientation (ψ, φ, θ) (e.g., roll, pitch, yaw) of the hovercraft 49 are taken from the reference inertial navigation system mounted on the hovercraft 49. As shown in FIG. 1B, the roll ψ is the angle between the vectors x_{hovercraft} and x_{runway}; the pitch φ is the angle between the vectors y_{hovercraft} and y_{runway}; and the yaw ψ is the angle between the vectors z_{hovercraft} and x_{runway}. The yaw is also referred to herein as the heading. The navigation system 32 averages and/or filters multiple measurements over a period of time to determine a precise geographic location and to determine a precise orientation of the hovercraft 49. While positioned in the known geographic location, the hovercraft 49 orients itself to be in line with the glide slope of angle for an aircraft during approach for landing at the runway 66. When the hovercraft 49 moves to another known geographic location, it reorients itself to be in line with the glide slope of angle for the aircraft during approach for landing at the runway 66 from that position. The determination of the orientation of the runway 66 is a determination of the i^{th} orientation 131-i of the hovercraft 49 with respect to the orientation of the centerline 67 of the runway 66 along the axis y_{runway}, wherein i is an integer indicative of the i^{th} orientation. The orientation of the centerline 67 (e.g., y_{runway}) in the earth's coordinate system (xₑₐᵣₜₕ, yₑₐᵣₜₕ, zₑₐᵣₜₕ) is known.

The position (lat, long, alt) of the hovercraft 49 is subtracted from the origin (0, 0, 0) of the coordinate system to generate the translational differences (Δlat, Δlong, Δalt) for each image. These translational differences (Δlat, Δlong, Δalt) for each image are referred to herein as the “translational parameters” for said image. Likewise, the orientation 131-i of the hovercraft 49 with respect to the orientation of the centerline 67 of the runway is determined to generate the rotational differences (Δψ, Δφ, Δθ) for each image. These rotational differences (Δψ, Δφ, Δθ) for each image are referred to herein as “rotational parameters” for each image. The translational parameters and rotational parameters are combined to form translation/rotation coordinates.

While the navigation system 32 is averaging measurements, a photograph of the runway 66 is obtained in which a runway axes origin (x_{runway}=0, y_{runway}=0, z_{runway}=0) is within in the field of view of the calibration camera 31. In this manner, the orientation 131-i is approximately aligned with and overlapping the connecting line 132-i that extends from the origin of the hovercraft 49 (x_{hovercraft}=0, y_{hovercraft}=0, z_{hovercraft}=0) in the oriented hovercraft 49 to the runway axes origin (x_{runway}=0, y_{runway}=0, z_{runway}=0). As shown in FIGS. 1A and 1C, the runway axes origin (x_{runway}=0, y_{runway}=0, z_{runway}=0) is positioned in the center of an edge 76 of the runway 66 that is closest to the hovercraft 49. The runway axes origin (x_{runway}=0, y_{runway}=0, z_{runway}=0) can also be at the longitude/lateral center of the entire runway 66 or lateral center of the other end of the runway 66.

The translational parameters and rotational parameters are stored in a database. In another embodiment the positions and the orientations are associated with the image and stored in the database without the subtraction. Thus, the calibrated set of offline-reference images of the runway are associated with the precise and accurate difference (Δlat, Δlong, Δalt) in location with respect to the runway axes origin (x_{runway}=0, y_{runway}=0, z_{runway}=0) and the precise and accurate difference Δψ, Δφ, Δθ in orientation with respect to the orientation of the centerline 67 of the runway 66. The precision and accuracy of the parameters are obtained using high quality navigation systems and by averaging over multiple measurements. This exercise only has to be performed as required. In one implementation of this embodiment, the calibration process is required only once per lifetime per the airport runway. In another implementation of this embodiment, the calibration process is required twice per lifetime per the airport runway with one process being done during the day and the other process being done during the night.

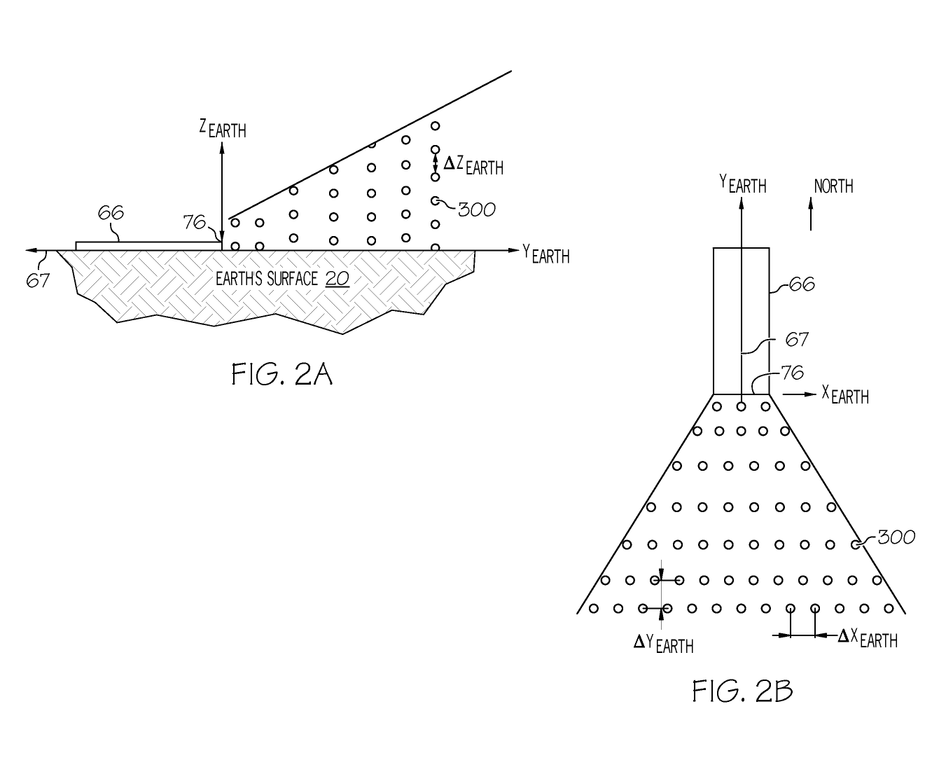

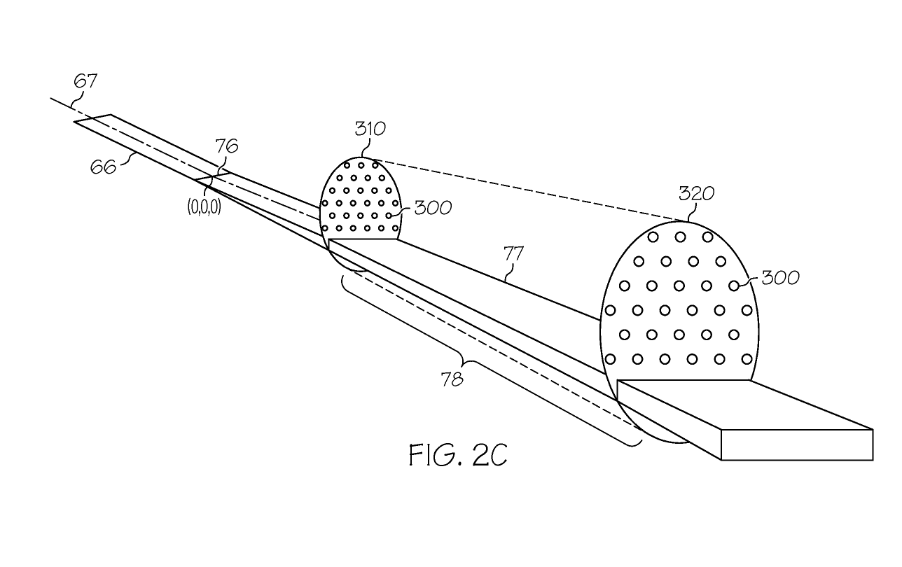

FIGS. 2A and 2B show geographic locations of calibration points represented generally at 300 from which a calibrated set of the offline-reference images are collected during a calibration process in accordance with the present invention. FIG. 2A shows a view of the runway 66 in the (yₑₐᵣₜₕ, zₑₐᵣₜₕ) plane, in which the centerline 67 is parallel to the yₑₐᵣₜₕ. FIG. 2B shows a view of the runway 66 of FIG. 2A in the (xₑₐᵣₜₕ, yₑₐᵣₜₕ) plane. FIG. 2C shows an oblique view of the runway 66 of FIGS. 2A and 2B and an extent of the region 78 in which calibration points 300 are required. An i^{th} calibration point 300-i is the geographic location in which a photograph of runway 66 is captured and associated with the geographic coordinates (lat, long, alt) and the rotational parameters (Δψ, Δφ, Δθ) of the orientation 131-i with respect to the centerline 67 of the runway 66. The spatial region 77 (FIG. 2C) in indicative of the glide slope of angle for an aircraft during approach for landing at the runway 66.

The calibration points 300 form a three-dimensional (3D) array within the space between the region 310 and region 320 (FIG. 2C). A single image of the runway 66 is taken from each calibration point 300 and, for each image, the associated differences (Δlat, Δlong, Δalt) with reference to the origin (0, 0, 0) and Δψ, Δφ, Δθ with respect to the orientation of the centerline 67 of the runway 66 are determined. The calibration points 300 are latitudinally offset (Δyₑₐᵣₜₕ), longitudinally offset (Δxₑₐᵣₜₕ) (FIG. 2B), and vertically offset (Δzₑₐᵣₜₕ) from each other. The maximum width and maximum range at various distances from the front edge 76 of the runway 66 may be similar to the ILS localizer and glide slope ranges. In one implementation of this embodiment, the calibration points 300 are offset from each other by less than a few hundred meters in a longitudinal direction (Δxₑₐᵣₜₕ), by less than 500 meters in a latitudinal direction (Δyₑₐᵣₜₕ), and by less than 500 meters in a vertical (altitudinal) direction (Δzₑₐᵣₜₕ).

In a pre flight phase, the set of calibrated-offline-reference images for at least the destination runway 166 and the associated translation/rotation coordinates 65 are loaded into the aircraft. The downloading is done in a manner that is similar to down loading a flight plan or an enhanced ground proximity warning system (EGPWS) database loading. The sets of calibrated-offline-reference images can be images from a stereo camera, infrared images for night/low visibility, and/or a collection of selected feature points in each image. The selected features include, but are not limited to, runway corners, the centerline of the runway, and/or visible static airport landmarks, such as buildings or unique geological features.

In one embodiment of the calibration process, selected features of the runway 66 are extracted from the set of images and the extracted features are used in place of the complete image. In another embodiment of the calibration process, image interpretation techniques render 3-D visualization of the runway 66. In this case, a set of images is rendered using image interpretation techniques and is converted to a three-dimensional picture. These three-dimensional pictures are loaded along with the database that includes the translation and rotational coordinates, onto the onboard computer memory along with the flight plan. The computer (not shown) includes at least the storage medium 121 and the software 120, and the processor 90.

In one implementation of this embodiment, the navigation system 32 is a high quality system such as onboard inertial navigation system/global positioning system (INS/GPS), barometers, radar altimeters, wide area augmentation system (WAAS) and local area augmentation system (LAAS). In one implementation of this embodiment, the calibration camera 31 is a high resolution camera 31. The highest resolution possible resolution is available in a camera that has diffraction limited resolution lenses. In another implementation of this embodiment, the resolution of the calibration camera 31 is equivalent to the currently available 1920×1080 (1080 lines) of D-VHS, HD DVD, Blu-ray, or HDCAM SR formats. In yet another implementation of this embodiment, the resolution of the calibration camera 31 is equivalent to the currently available 1280×720 (720 lines): D-VHS, HD DVD, Blu-ray, HDV (miniDV). The calibration camera 31 can include any future developed technologies that increase the resolution of cameras.

In yet another implementation of this embodiment, the calibration camera 31 includes optical sensors are designed to detect spatial differences in EM (electro-magnetic) energy, such as solid-state devices (CCD, CMOS detectors, and infrared detectors like PtSi and InSb), tube detectors (vidicon, plumbicon, and photomultiplier tubes used in night-vision devices).

In yet another implementation of this embodiment, the camera 31 is a stereo camera 31. In yet another implementation of this embodiment, the camera 31 is an infrared camera 31. In yet another implementation of this embodiment, the hovercraft 49 has both a stereo camera and an infrared camera that are substantially co-located and that collect images from the same geographic location.

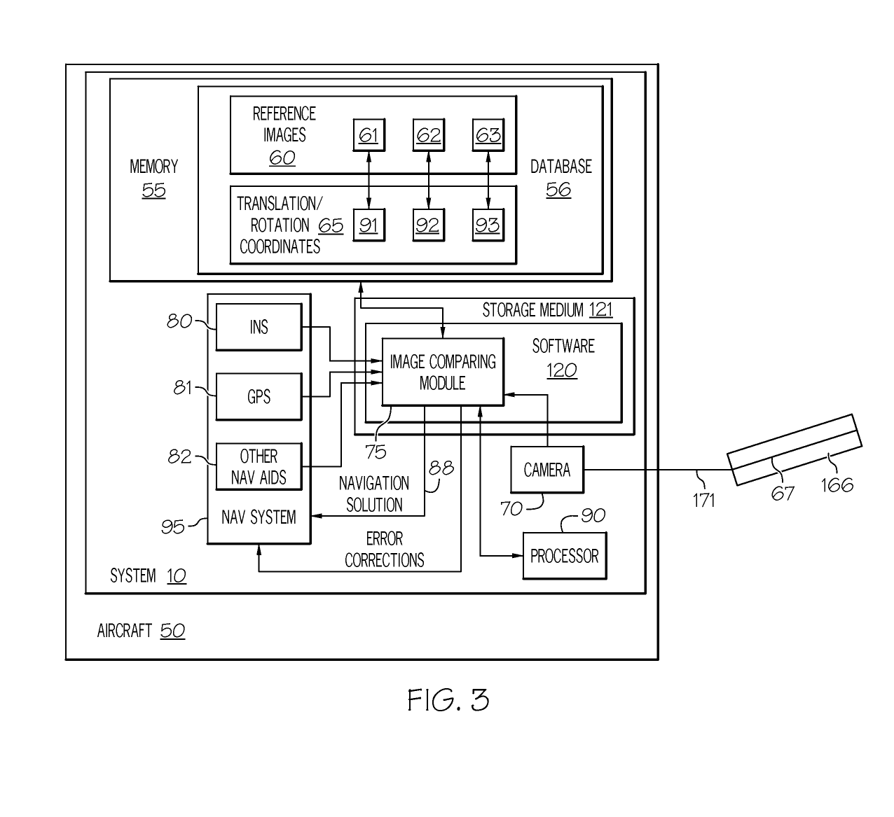

FIG. 3 is an embodiment of a system 10 to improve landing capability for an aircraft 50 in accordance with the present invention. The system 10 is installed on the aircraft 50. System 10 includes a real-time camera 70, a navigation system 95, a memory 55, at least one processor 90, and storage medium 121 (e.g., a processor-readable medium on which program instructions are embodied) storing software 120 including an image comparing module 75. In one implementation of this embodiment, the image comparing module 75 includes a Kalman filter. In another implementation of this embodiment, the memory 55, at least one processor 90, and storage medium 121 are included in a non-transitory computer. In yet another implementation of this embodiment, the image comparing module 75 includes an image-matching module to select a closest calibrated-image from the calibrated-offline-reference images. The closest calibrated-image most closely matches the most recently captured real-time image.

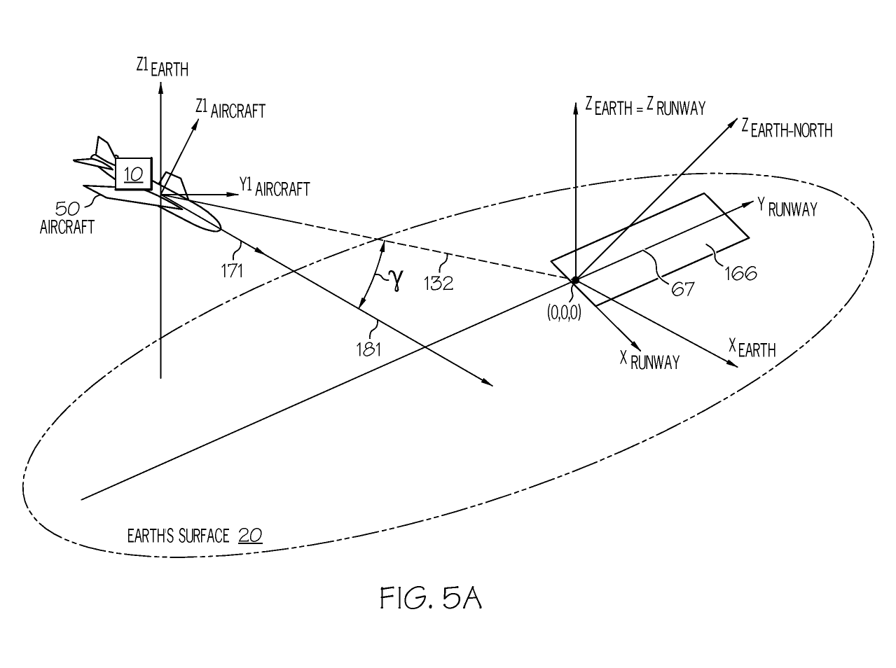

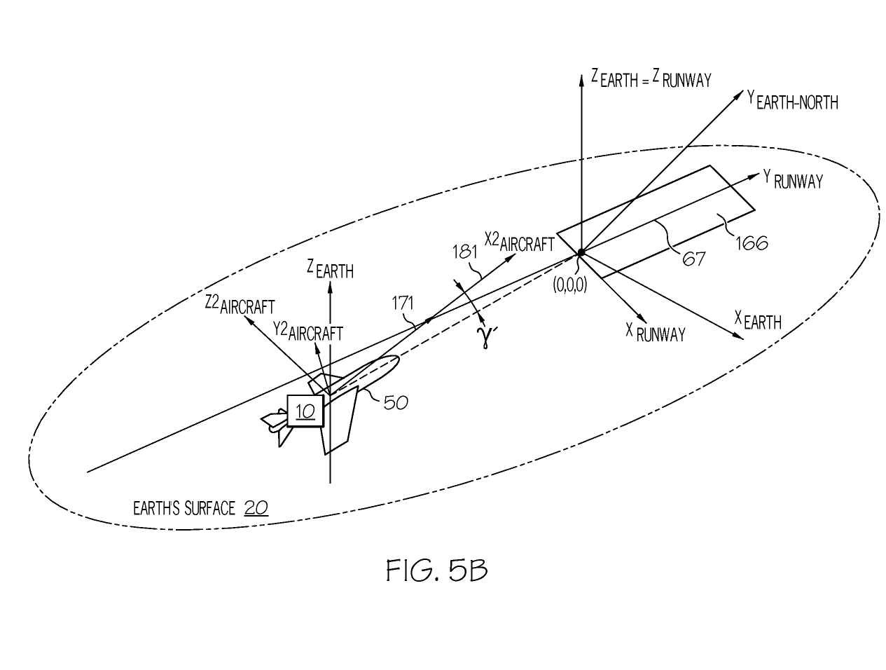

The orientation 171 of the aircraft 50 is represented generally as a line extending between the origin of the aircraft axes (x_{aircraft}=0, y_{aircraft}=0, z_{aircraft}=0) (see FIGS. 5A and 5B) and the runway axes origin (x_{runway}=0, y_{runway}=0, z_{runway}=0) at the destination runway 166.

The real-time camera 70 captures real-time images of a destination runway 166 during an approach to the destination runway 166. These images can be taken in high frequency samples based on the limitations of the camera and processing speed. The processor 90 (also referred to herein as a programmable processor 90) executes software 120 in the image comparing module 75 to compare the real-time images of the destination runway with the calibrated set of offline-reference images and to select respective closest calibrated-offline-reference images from the calibrated set of the offline-reference images for comparison with the associated real-time images. As defined herein, the “closest calibrated-offline-reference” is the calibrated-offline-reference image from the set of calibrated-offline-reference images that has a geographic location that is closest to the navigational coordinates obtained from the onboard navigation system 95. The processor 90 executes software 120 to evaluate translational differences and rotational differences between associated real-time images and selected closest calibrated-offline-reference images.

The programmable processor 90 executes software 120 and/or firmware that causes the programmable processor 90 to perform at least some of the processing described here as being performed by system 10. At least a portion of such software 120 and/or firmware executed by the programmable processor 90 and any related data structures are stored in storage medium 121 during execution. Memory 55 comprises any suitable memory now known or later developed such as, for example, random access memory (RAM), read only memory (ROM), and/or registers within the programmable processor 90. In one implementation, the programmable processor 90 comprises a microprocessor or microcontroller. Moreover, although the programmable processor 90 and memory 55 are shown as separate elements in FIG. 3, in one implementation, the programmable processor 90 and memory 55 are implemented in a single device (for example, a single integrated-circuit device). The software 120 and/or firmware executed by the programmable processor 90 comprises a plurality of program instructions that are stored or otherwise embodied on a storage medium 121 from which at least a portion of such program instructions are read for execution by the programmable processor 90. In one implementation, the programmable processor 90 comprises processor support chips and/or system support chips such as application-specific integrated circuits (ASICs).

The image comparing module 75 is a program-product including program instructions that are operable, when executed by the processor 90 (also referred to here as programmable processor 90) to cause the aircraft to implement embodiments of the methods described herein. The real-time camera 70 in aircraft 50 has an optical axis that is orientated with respect to the attitude of the aircraft by a known set of angles (lever arm). A matrix rotation process is used to adjust the images to offset any angular differences between the optical axis and the attitude of the aircraft 50. In one implementation of this embodiment, the optical axis of the real-time camera 70 is aligned to be parallel to and overlapping the orientation (attitude) of the aircraft 50. Such an embodiment simplifies the required calculations to improve landing capability of the aircraft 70 but is not required.

The navigation system 95 provides a geographic location and an orientation of the aircraft 50. The navigation system 95 includes an inertial navigation system 80 to provide information indicative of the orientation 171 (roll, pitch, heading) of the aircraft 50. The navigation system 95 includes a global positioning system receiver 81 to provide information indicative of a geographic location (lat, long, alt) of the real-time camera 70 to the software. In one implementation of this embodiment, the navigation system 95 includes other navigational aids 82. The real time images captured by the real-time camera 70 are associated with latitude, longitude, altitude and orientation of the aircraft 50 from the navigation system 95.

The memory 55 includes a database 56. The database 56 includes calibrated offline-reference images 60 and the translation/rotation coordinates 65 associated with the offline-reference images 60. The calibrated offline-reference images 60 and the translation/rotation coordinates 65 were previously calibrated in a calibration process as described above with reference to FIGS. 1A-2C. The exemplary calibrated offline-reference images 60 shown in FIG. 3 include three calibrated sets of the offline-reference images 61, 62, and 63 that are associated with three calibrated runways 66 at which the aircraft 50 may land in the future. The exemplary translation/rotation coordinates 65 shown in FIG. 3 include three calibrated sets of translation/rotation coordinates 91, 92, 93 that are correlated with the respective sets of the offline-reference images 61, 62, and 63. The offline-reference images 60 in the database 55 include at least one calibrated set of the offline-reference images 61 and the translation/rotation coordinates 65 include the associated calibrated sets of translation/rotation coordinates 91 for at least one destination runway 166.

The translation/rotation coordinates 65 include the difference in the known geographic location of the aircraft 50 with respect to the origin (0, 0, 0) on the runway 166 (e.g., translational differences (Δlat, Δlong, Δalt)). The translation/rotation coordinates 65 also include the orientation 171 of the aircraft 50 with respect to the centerline 167 of the runway 166 (e.g., rotational differences Δψ, Δφ, Δθ) that were previously generated for the plurality of images captured during the calibration process of the destination runway 167.

Specifically, the processor 90 compares how the real-time images need to be translated in latitude, longitude, and altitude for the real-time image to overlap the calibrated image. The amount of translation is based on an error in the global positioning system receiver 81. Likewise, the real-time orientation 171 (with respect to the orientation of the centerline 67 of the destination runway 166) is compared to the stored rotational parameters (Δψ, Δφ, Δθ) (with respect to the orientation of the centerline 67 of the destination runway 166). The processor 90 determines the angular offset between the real-time orientation 171 and the rotational parameters (Δψ, Δφ, Δθ). This angular offset indicates how the real-time orientation 171 is to be rotated to correct for errors in the inertial navigation system 80. Any differences are the result of errors in the navigation system 95 and corrections to those errors are sent to the navigation system 95 from the software 120.

In one implementation of this embodiment, if the aircraft 50 is not located exactly on a calibration point 300, the amount of translational shift from the current location to the exact geographic location of the nearest calibration point is applied to the current navigational readings and then the shifted navigational readings are compared to the stored translational parameters (Δlat, Δlong, Δalt) with reference to the origin (0, 0, 0). In another implementation of this embodiment, if the aircraft 50 is not located exactly on a calibration point 300, the image comparing module 75 interpolates two or more of the closest images from the calibrated set of the offline-reference images 61.

The image comparing module 75 outputs a navigation solution 88 and corrections to the inertial navigation system 80, the global positioning system receiver 81, and the other navigational aids 82 in the navigation system 95.

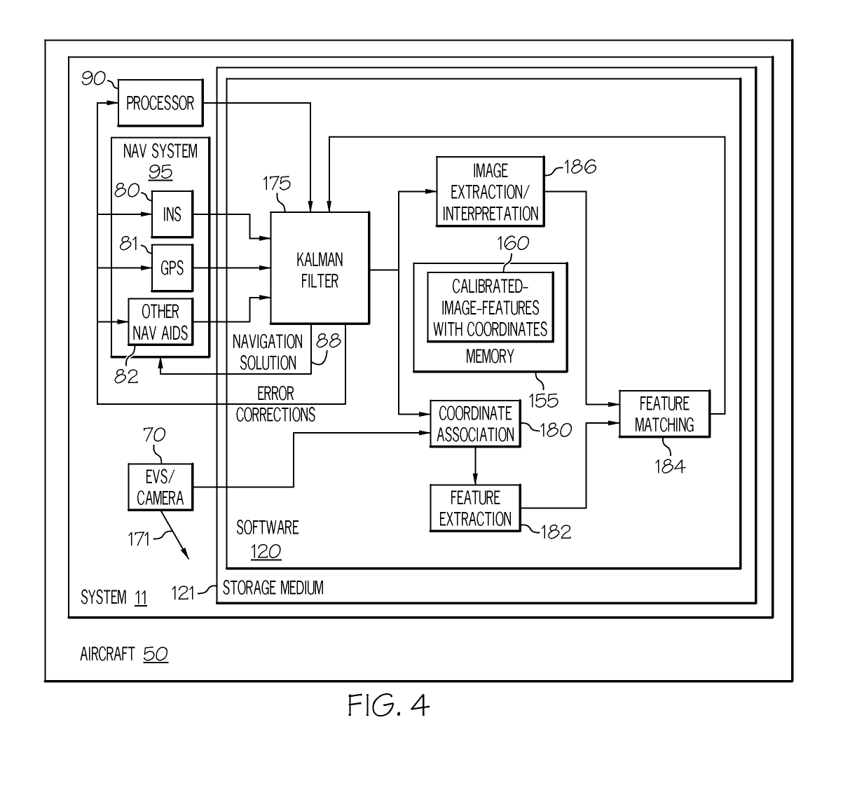

FIG. 4 is an embodiment of a system 11 to improve landing capability for an aircraft in accordance with the present invention. A feature extraction technique is employed by system 11 to extract and render important features in the real time image in order to compare with the features extracted from offline reference images. This reduces the size of images to be loaded, which can be a constraint in commercial aircraft. In one implementation of this embodiment, the features are markings on the runway, runway signaling lights, and other signaling board/equipment. The system 11 is installed on the aircraft 50. System 11 includes a real-time camera 70 (also referred to herein as enhanced vision system (EVS) 70), a navigation system 95, a memory 155, a processor 90, and software 120 in a storage medium 121 (e.g., a processor-readable medium on which program instructions are embodied). The software 120 is a program-product including program instructions that are operable, when executed by the processor 90 to cause the aircraft 50 to implement embodiments of the methods described herein. The onboard memory 155 is also referred to herein as an “onboard computer memory 155.”

The navigation system 95 is similar in structure and function to the navigation system 95 described above with reference to FIG. 3. The real-time camera 70 is similar in structure and function to real-time camera 70 described above with reference to FIG. 3. The real time images captured by the real-time camera 70 are associated with latitude, longitude, altitude and orientation of the aircraft 50 from the navigation system 95 while landing.

The memory 155 includes a data indicative of calibrated image features with the associated coordinates. The calibrated-image-features with coordinates 160 include selected features that were extracted from a portion of the offline-reference images 60 of a destination runway 166 at which the aircraft 50 is scheduled to land. The translation/rotation coordinates associated with said selected features are extracted from a portion of the offline-reference images 60 (FIG. 3).

The software 120 includes a Kalman filter 175, an image extraction/interpretation module 186, a coordinate association module 180, a feature extraction module 182, and a feature matching module 184.

The Kalman filter 175 receives input from the navigation system 95, the processor 90, and the feature matching module 184. The Kalman filter 175 outputs data to the image extraction/interpretation module 186, and the coordinate association module 180. The real-time camera 70 outputs information indicative of real-time images collected during an approach to the destination runway 166 (not shown in FIG. 4) to the coordinate association module 180.

The coordinate association module 180 receives the input from the Kalman filter 175 and the real-time camera 70. The coordinate association module 180 determines the real-time coordinates of the aircraft 50 from the input from the Kalman filter 175 and associates the real-time aircraft coordinates with the real-time images from the real-time camera 70. The coordinate association module 180 outputs the associated coordinates and images to the feature extraction module 182. The feature extraction module 182 extracts real-time features of the real-time images that are associated with the image features for the destination runway 166. The features extracted from the real-time images at the feature extraction module 182 are sent to the feature matching module 184.

The image extraction/interpretation module 186 receives the input from the Kalman filter 175 and based on the geographic location of the aircraft 50 retrieves a closest calibrated-offline-reference from the calibrated-image-features with coordinates 160 that are stored in the memory 155. The sequentially received real time images are compared, frame by frame, with the closest reference image from the set of calibrated-offline-reference images. In yet another implementation of this embodiment, the image extraction/interpretation module 186 includes an image-matching module to select a closest calibrated-image from the calibrated-offline-reference images. The closest calibrated-image most closely matches the most recently captured real-time image.

The features from the closest image are sent to the feature matching module 184. The feature matching module 184 receives the calibrated input from the image extraction/interpretation module 186 and receives the real-time input from the feature extraction module 182. The feature matching module 184 aligns the extracted calibrated-image features with the extracted features from the real-time images. If the features from the real-time camera image do not match with the features from the offline calibrated image, the feature matching module 184 uses image interpretation techniques to interpolate a latitude, longitude, and altitude from the latitude, longitude, and altitude of two or more closest images. Errors in the geographic location and the orientation provided by the navigation system 95 are determined by the aligning. The feature matching module 184 makes a comparison of the runway lines from the real-time camera image and reference image provides the error in the translational and rotational coordinates. This error is fed as additional information to the Kalman filter 175 to correct errors in the navigation system 95.

The Kalman filter 175 outputs a navigation solution 88 and error corrections to the inertial navigation system 80, the global positioning system receiver 81, other navigational aids 82 in the navigation system 95, and the processor 90.

In both system 10 of FIG. 3 and system 11 of FIG. 4, the lateral and vertical deviation of the aircraft 50 from the runway centerline 67 is estimated as differences between the orientation and location of the real-time images and the calibrated reference images are determined and as the translational and rotational references are available. This information is used to provide landing guidance. The systems 10 and/or 11 thus provide alternate methods for landing without the use of costly ground instruments like ILS, GBAS. The systems 10 and/or 11 provide an extension to enhanced vision systems (EVS) and EGPWS applications. The systems 10 and/or 11 work at low runway visual range (RVR) conditions and at night, if camera 70 is an infra red camera. An infrared camera is capable of providing enough information on the runway and taxiway borders for system 10 or 11 to operate. The systems 10 and/or 11 provide an alternate method and system to check the integrity of radio altimeter, INS, GPS, and other navigation systems.

In one implementation of this embodiment, additional filtering and estimation techniques to enhanced infrared cameras and high accurate navigation systems (for reference mapping/calibrated offline reference images collection) provide pure Integrated Mapping and Geographic Encoding System (IMAGE) based navigation. Such a system is implemented during landing using an INS 80 and the imaging system described herein, without use of external aids like GPS, radar altimeters.

FIG. 5A shows a three-dimensional representation of aircraft 50 during an approach to a destination runway 166 in accordance with the present invention. FIG. 5B shows a three-dimensional representation of the aircraft 50 of FIG. 5A at a different time during the approach to the destination runway 166 in accordance with the present invention. As shown in FIGS. 5A and 5B, system 10 is installed in the aircraft 50. However, system 11 of FIG. 3 can be installed in the aircraft 50 in place of system 10.

Real-time images are captured by the real-time camera 70 in system 10. As shown in FIGS. 5A and 5B, the orientation 171 of the aircraft 50 (FIG. 3) is aligned parallel to and overlapping an attitude line 181 of the aircraft 50. In FIG. 5A, the aircraft 50 is in a first known geographic location (x1_{aircraft}, y1_{aircraft}, z1_{aircraft}) and the attitude line 181 has an orientation shown as angle γ with reference to the connecting line 132 that extends between the origin of the aircraft axes (x1_{aircraft}=0, y1_{aircraft}=0, z1_{aircraft}=0) and the runway axes origin (x_{runway}=0, y_{runway}=0, z_{runway}=0). In FIG. 5B, the aircraft 50 is in a second known geographic location (x2_{aircraft}, y2_{aircraft}, z2_{aircraft}) and the attitude line 181 has an orientation shown as angle γ′ with reference to the connecting line 132 that extends between origin of the aircraft axes (x2_{aircraft}=0, y2_{aircraft}=0, z2_{aircraft}=0) and runway axes origin (x_{runway}=0, y_{runway}=0, z_{runway}=0). The attitude line 181 is a line that is parallel to and overlapping a vector indicative of the orientation of the aircraft 50. The GPS, camera and other sensors have a lever arm between these sensors and the origin of the aircraft axes (x_{aircraft}=0, y_{aircraft}=0, z_{aircraft}=0). The GPS, camera and other sensors are compensated, based on the lever arm, when the outputs of these systems are used for navigation. When an image comparison is made, as describe herein, the lever-arm corrected inputs are provided to navigation system 95.

The angles γ and γ′ are projected onto the coordinates of the earth (xₑₐᵣₜₕ, yₑₐᵣₜₕ, zₑₐᵣₜₕ) to generate a set of angles related to the pitch, roll and yaw of the aircraft 50. The angles γ and γ′ are projected onto the coordinates of the runway (x_{runway}, y_{runway}, z_{runway}) to generate a set of angles related to centerline 67 of the runway 166. The image comparing module 75 receives the input from the navigation system 95 and, based on the geographic location (lat, long, alt) of the aircraft 50, retrieves a closest image from the calibrated set of the offline-reference images 61 associated with the known location. In one implementation of this embodiment, if the aircraft 50 is not located exactly on a calibration point 300, the image comparing module 75 interpolates two or more of the closest images from the calibrated set of the offline-reference images 61.

The image comparing module 75 also retrieves the known geographic location and orientation of the aircraft 50. The difference between the orientation of the connecting line 132 and the attitude line 181 is able to be determined from the retrieved data in offline-reference images 61, the known geographic location, and the orientation of the aircraft 50 (FIG. 3). If onboard translational and rotational parameters are perfect, the rendered image and real time image taken by onboard camera matches perfectly.

Due to inherent errors in the inertial navigation system 80 and global positioning system receiver 81 (also referred to herein as INS/GPS 80/81), the images do not match. Despite the errors inherent in the INS/GPS 80/81, the systems and methods describe herein allow a pilot to safely land an aircraft without any ground based input since the Kalman filter provides corrections to the inertial navigation system 80 and the a global positioning system receiver 81. If system 11 is being used, feature extraction and feature matching techniques or image comparison techniques are used to evaluate the translational and rotational difference between the calibrated reference images and real-time images. The systems and method described herein associate the images with coordinates based on aircraft INS/GPS 80/81 translational and rotational output.

The systems and method described herein are used for closely matching reference image based on latitude, longitude, altitude information of onboard INS/GPS 80/81 (e.g., navigation system 95). This difference is fed as error input to INS/GPS from the Kalman filter to enhance the performance of INS/GPS 80/81. The frequency of this error input depends on the execution time of above algorithm. The rate at which the real time images are taken, processed, and the errors are identified and fed to the Kalman filter depends upon 1) the capability of the real-time camera to provide real-time images, 2) the processing capability of the on-board computer, and 3) the processing capability of the Kalman filter. In one implementation of this embodiment, rate at which the real time image is taken, processed and errors identified and fed to the Kalman filter is less than a few hundred milliseconds. Using high end processors 90, the rate at which this algorithm executes can be enhanced to few milliseconds so that it meets required standards for landing. Thus, the Kalman filter 175 provides corrections to the navigation system 95 to improve the accurately and precision of the estimates distance and orientation of aircraft 50 with respect to the destination runway 166.

In one implementation of this embodiment, twin cameras are used to improve safety and reliability. In another implementation of this embodiment, system 10 and/or 11 implement a combination of a forward looking infrared (IR) camera and a stereo camera in order to provide precision landing under all conditions.

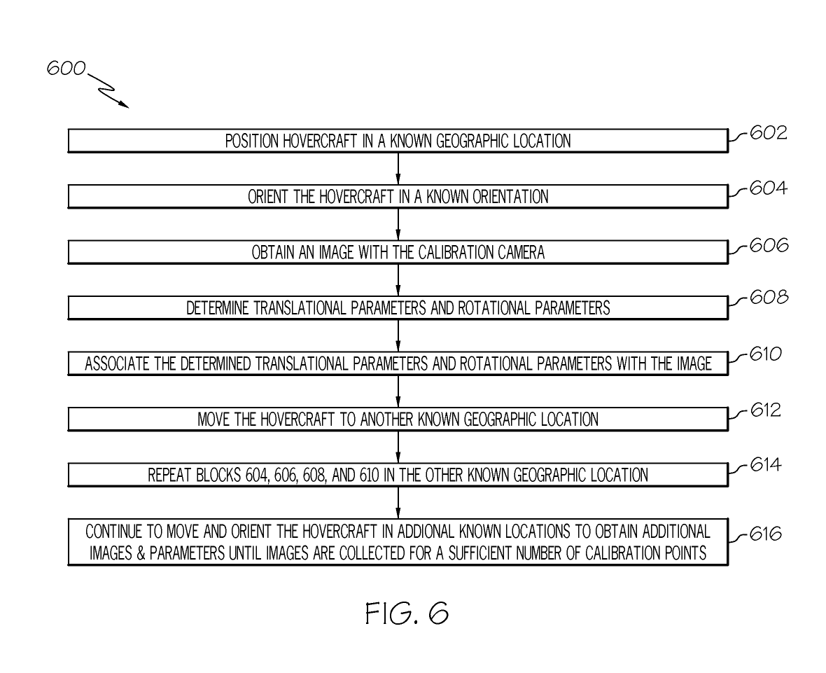

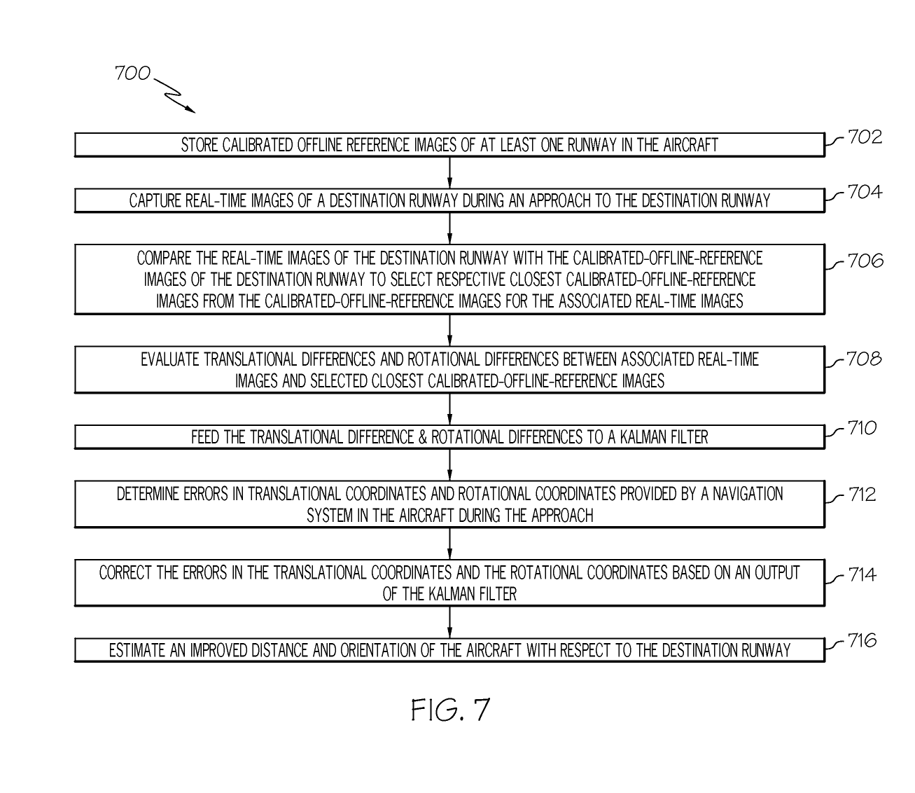

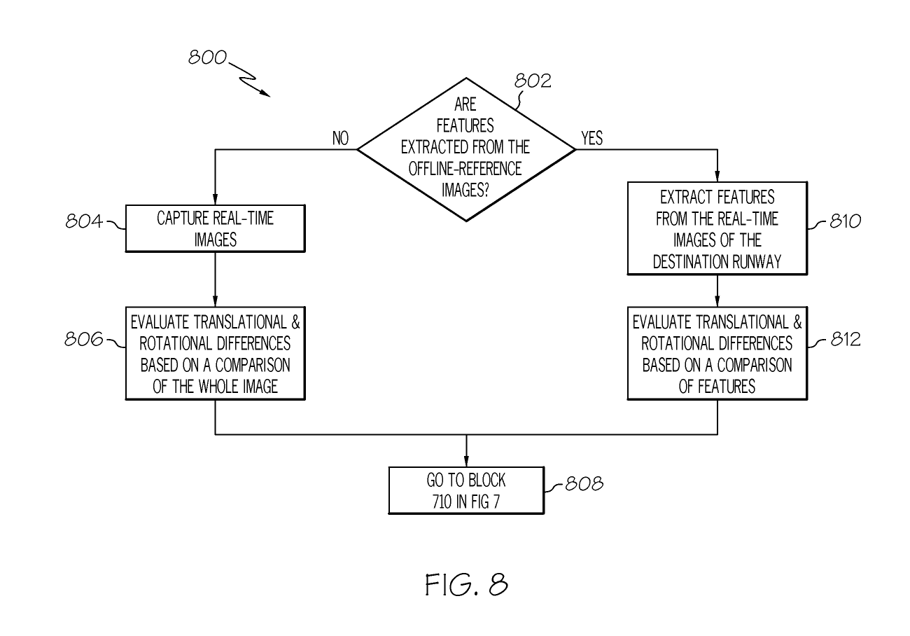

FIG. 6 is a flow diagram of one embodiment of a method to generate a calibrated set of the offline-reference images in accordance with the present invention. FIG. 7 is a flow diagram of one embodiment of a method to improve landing capability for an aircraft in accordance with the present invention. The methods 600, 700, and 800 together provide details of the method for improving landing capability for an aircraft 50. Method 600 is described with reference to FIGS. 1A-2C.

At block 602, a calibration camera 31 is positioned in a hovercraft 49 in a known geographic location (x_{hovercraft}, y_{hovercraft}, z_{hovercraft}), also referred to herein as (latitude hovercraft, longitude_{hovercraft}, altitude_{hovercraft}). If this is the first calibration point 300, the known geographic location is a first known geographic location (x1_{hovercraft}, y1_{hovercraft}, z1_{hovercraft}). In one implementation of this embodiment, two calibration cameras are located in the hovercraft 49. For example, a stereo camera to collect images of the runway during the day and an infrared camera to collect images of the runway during the night are both installed in the hovercraft. These two cameras can be used during separate calibration processes, one taking place during the day and the other taking place at night.

At block 604, the hovercraft 49 is oriented in a known orientation represented generally at 131-1 (FIG. 1A). The orientation 131 is parallel to and approximately overlapping a connecting line 132 from the origin of the hovercraft 49 (x_{hovercraft}=0, y_{hovercraft}=0, z_{hovercraft}=0) to the runway axes origin (x_{runway}=0, y_{runway}=0, z_{runway}=0). The runway axes origin (x_{runway}=0, y_{runway}=0, z_{runway}=0) is approximately centered in the image of the calibration camera 31, while the hovercraft 49 is in the known orientation.

At block 606, an image is obtained by the calibration camera 31 while the hovercraft 49 is positioned in the known geographic location (latitude1_{hovercraft}, longitude1_{hovercraft}, altitude1_{hovercraft}) and orientated in the known orientation. If this is the first calibration point 300, the obtained image is a first image taken from a first known geographic location (x1_{hovercraft}, y1_{hovercraft}, z1_{hovercraft}) and orientated in the known orientation 131-1. In one implementation of this embodiment, a first calibration camera collects images during the day time to generate a daytime calibrated set of offline-reference images for a runway and a second calibration camera collects images during the night to generate a night calibrated set of offline-reference images for runway. The day and night calibrated set of offline-reference images are collected during the day and night, respectively. In one implementation of this embodiment, the night calibrated set of offline-reference images are collected by an infra-red camera during the night. In another implementation of this embodiment, the day calibrated set of offline-reference images are collected by a stereo camera during the day.

At block 608, translational parameters and rotational parameters are determined with reference to a known coordinate of runway 66. If this is the first calibration point 300, the first translational parameters (Δlat1, Δlong1, Δalt1) and first rotational parameters (Δψ1, Δφ1, Δθ1) are determined for association with the first image.

At block 610, the determined translational parameters and the determined rotational parameters are associated with the image. If this is the first calibration point 300, the determined first translational parameters (Δlat1, Δlong1, Δalt1) and the determined first rotational parameters (Δψ1, Δφ1, Δθ1) are associated with the first image.

At block 612, the hovercraft 49 is moved to another known geographic location (x_{hovercraft}, y_{hovercraft}, z_{hovercraft}). If this is the first calibration point 300, the hovercraft 49 and the calibration camera 31 are moved to a second known geographic location (x2_{hovercraft}, y2_{hovercraft}, z2_{hovercraft}) from the first known geographic location (x1_{hovercraft}, y1_{hovercraft}, z1_{hovercraft}). In one implementation of this embodiment, the hovercraft 49 is moved to the second known geographic location that is separated from the first known geographic location by less than a few hundred meters in a longitudinal direction, by less than a few hundred meters in a longitudinal direction, and by less than a few hundred meters in a vertical direction.

At block 614, blocks 604, 606, 608, and 610 are repeated in the other known geographic location (x_{hovercraft}, y_{hovercraft}, z_{hovercraft}). If this is the second calibration point 300, the other known geographic location is a second known geographic location (x2_{hovercraft}, y2_{hovercraft}, z2_{hovercraft}) and the second translational parameters (Δlat2, Δlong2, Δalt2) and second rotational parameters (Δψ2, Δφ2, Δθ2) are determined for and associated with the second image taken from the second known geographic location (x2_{hovercraft}, y2_{hovercraft}, z2_{hovercraft}).

At block 616, the hovercraft is moved to and orientated in additional known geographical locations, additional images are collected (as in block 606), and additional translational parameters and rotational parameters are determined (as in block 608), and associated with the respective collected images (as in block 610). The process continues until images have been collected for a sufficient number of calibration points 300 that are positioned near the runway 66 as described above with reference to FIGS. 2A-2C. For example, the hovercraft 49 is moved to a third known geographic location (x3_{hovercraft}, y3_{hovercraft}, z3_{hovercraft}) and blocks 604, 606, 608, and 610 are repeated in the third known geographic location (x3_{hovercraft}, y3_{hovercraft}, z3_{hovercraft}).

In this manner, a plurality of images of the at least one runway are collected with a calibration camera 30 in a hovercraft 49. The plurality of images are collected from an associated plurality of known geographic locations (x_{hovercraft}, y_{hovercraft}, z_{hovercraft})=(latitude_{hovercraft}, longitude_{hovercraft}, altitude_{hovercraft}) while the hovercraft 49 is orientated in a known orientation 131. The plurality of images of the runway is associated with the associated known geographic location. The plurality of images of a given runway forms a calibrated set of the offline-reference images for the given runway. The generated known geographic location and orientation of the aircraft for each known geographic location are associated with one of the plurality of images. The known geographic location and orientation of the aircraft is generated with reference to a centerline 67 of the given runway 66.

Specifically, the differences between the latitude, longitude, and altitude of the hovercraft 49 and the origin (0, 0, 0) are the translational parameters (Δlat, Δlong, Δalt). Likewise, the rotational parameters are the angular differences between the orientation of the centerline 67 and the orientation angles (Δψ, Δφ, Δθ) indicative of roll, pitch, and yaw, respectively, of the hovercraft 49 when the hovercraft 49 is aligned to the glide slope of angle for landing at the runway 66 (i.e., directed toward the origin (0, 0, 0)). The translational parameters (Δlat, Δlong, Δalt) and the rotational parameters (Δψ, Δφ, Δθ) are referred to herein as translation/rotation coordinates 65.

The first, second, and third known geographic locations are calibration points 300 located in view of the same runway. In this manner, a calibrated set of the offline-reference images 61 are collected for the runway. After the calibrated set of the offline-reference images 61 are collected for a first runway, a second calibrated set of the offline-reference images 62 are collected for a second runway by the hovercraft 49 hovering in a plurality of known geographic locations in view of the second runway, until images have been collected for a sufficient number of calibration points 300. The process is repeated one or more time per runway, as required to keep the calibration images current with the environment of the runway. For example, if new buildings are constructed near the runway, the new buildings can be added as features in the calibration images.

FIG. 7 is a flow diagram of one embodiment of a method 700 to improve landing capability for an aircraft in accordance with the present invention. Method 700 is described with reference to system 10 of FIG. 3, and FIGS. 5A, and 5B. Method 700 is also applicable to system 11 of FIG. 4 as is understandable to one skilled in the art upon reading this document.

At block 702, calibrated-offline-reference images of at least one runway are stored in the aircraft 50 along with the flight plan to a destination runway 166. The calibrated-offline-reference images of at least the destination runway 166 are stored in an onboard memory 55 in the aircraft 50. The onboard memory 55 is also referred to herein as an “onboard computer memory 55.” The translation/rotation coordinates 65 associated with the calibrated-offline-reference images of at least the destination runway 166 are loaded into a database 56 that is stored in the memory 55 in the aircraft 50. The known geographic location and orientation of the aircraft is taken with reference to a centerline 67 of the destination runway 166. The translation/rotation coordinates 65 associated with the calibrated-offline-reference images 60 of at least the destination runway 166 were generated as described above with reference to method 600. In one implementation of this embodiment, a first calibrated set 61 of the offline-reference images for a destination runway is loaded in a database 56 in the memory 55 along with a second calibrated set 62 of the offline-reference images 60 for a second runway. In this case, the second runway is an alternative-destination runway. In one implementation of this embodiment, features from the offline-reference images 60 are extracted prior to storing and only those extracted features are stored.

At block 704, real-time images of a destination runway 166 are captured during an approach to the destination runway 166. The real-time camera 70 capturing real-time images of the destination runway 166 during the approach involves capturing a plurality of real-time images in succession with the real-time camera 70 on the aircraft 50, while the aircraft 50 is orientated in a known direction. The real-time camera 70 can be one of forward looking infra-red camera or a stereo camera.

In one implementation of this embodiment, a feature extraction module 182 in conjunction with a coordinate association module 180 in the software 120 on system 11 (FIG. 4) extracts features from the real-time images of the destination runway 166 during the approach to the destination runway 166. In this embodiment, the extracted real-time features are associated with the features extracted from the offline-reference images 60 prior to storing in the calibrated-image-features with coordinates 160 in the memory 155.

At block 706, the real-time images of the destination runway 166 are compared with the calibrated-offline-reference images 61 (FIG. 3) of the destination runway 166 to select respective closest calibrated-offline-reference images from the calibrated-offline-reference images 61 for the associated real-time images that were captured at block 702. The comparison is initiated based on input from the navigation system 95 in the aircraft 50. The navigation system 95 provides a geographic location of the aircraft 50 when the real-time image is captured. The calibrated-offline-reference images that were obtained at locations closest to the geographic location of the aircraft 50 when the real-time image is captured are reviewed first. For example, there are four to six calibration points 300 (FIGS. 2A-2C) at locations that are nearest neighbors to the geographic location of the aircraft 50 when the real-time image is captured. Those images are selected for a comparison at the image comparing module 75. The data can be transposed or interpolated as described above.

At block 708, translational differences and rotational differences are evaluated between associated real-time images and selected closest calibrated-offline-reference images. In one implementation of this embodiment, a matrix rotation process is used to rotate the origin of the real-time image into the origin of the calibrated-offline-reference image. The amount of rotation difference is used to correct errors in the navigation system 95. Any translation required to place the real-time image at the known location of the calibration point 300 is included prior to implementation of the matrix rotation process. Likewise, any interpolation of images from nearest calibration points 300 is done prior to implementation of the matrix rotation process.

At block 710, the evaluated translational differences and rotational differences are fed to a Kalman filter, such as Kalman filter 175 in system 11 (FIG. 4). For example, the evaluated translational differences and rotational differences are fed to software 120 and/or the software 120 of system 10 (FIG. 3).

At block 712, the software 120 (Kalman filter 175) determines errors in translational coordinates (lat, long, alt) and rotational coordinates (ψ, φ, θ) provided by the navigation system 95 in the aircraft 50 during the approach based on the evaluated translational differences and rotational differences input to the software 120 (Kalman filter 175). The translational coordinates (lat, long, alt) are indicative a geographic location of the aircraft 50. The rotational coordinates are indicative of the orientation or attitude (ψ, φ, θ) of the aircraft 50. Thus, the software 120 determines errors in information indicative of the geographic location of the aircraft 50 received from the global positioning system receiver 81 and in the information indicative of the orientation of the aircraft 50 received from the inertial navigation system 80 during an approach to the destination runway 166. The error determination is based on the translational differences and rotational differences that were determined at block 708.

At block 714, errors in the translational coordinates and the rotational coordinates are corrected based on an output of error corrections from the Kalman filter. In one implementation of this embodiment, the Kalman filter (not shown in FIG. 3) outputs error corrections for the determined errors to the navigation system 95 to correct for the determined errors. In another implementation of this embodiment, the Kalman filter 175 in the system 11 (FIG. 4) outputs error corrections for the determined errors to the navigation system 95 to correct for the determined errors.

At block 716, the navigation system 95 estimates an improved distance (Δlat, Δlong, Δalt) and orientation (Δψ, Δφ, Δθ) of the aircraft 50 with respect to the destination runway 166 based on the correction of the navigation system 95. In this manner, the navigation system 95 precisely and accurately provides a known geographic location and orientation of the aircraft 50 with reference to a centerline 67 of the destination runway 166.

FIG. 8 is a flow diagram of one embodiment of a method 800 to improve landing capability for an aircraft in accordance with the present invention. Method 800 is described with reference to system 10 of FIG. 3, system 11 of FIG. 4, and FIGS. 5A, and 5B. At block 802, it is determined if features have been extracted from the calibrated-offline-reference stored in the memory. The processor 90 recognizes if the complete reference images 60 (FIG. 3) are stored in memory 55 of system 10 or if calibrated-image-features of the complete reference image are stored in the memory 155 of system 11. If it is determined that the reference images 60 (FIG. 3) are stored in memory 55 of system 10, the flow proceeds to block 804. At block 804, the real-time camera 70 captures real-time images. At block 806, system 10 evaluates translational differences and rotational differences between associated real-time images and selected closest calibrated-offline-reference images based on a comparison of the reference images 60 to the real-time images. The process implemented at block 806 is described above with reference to blocks 706 and 708 in method 700 FIG. 7. Then the flow proceeds to block 808. At block 808, the process flows to block 710 in FIG. 7.

If it is determined, at block 802, that the calibrated-image-features 160 (FIG. 4) are stored in memory 155 of system 11, the flow proceeds to block 810. At block 810, the feature extraction module 182 extracts real-time features of the real-time images that are associated with the image features for the destination runway 166. At block 812, system 11 evaluates translational differences and rotational differences based on a comparison of the extracted features. The feature matching module 184 compares the features extracted from the real-time images at the feature extraction module 182 with the calibrated-image-features for the closest calibrated-offline-reference image (or an interpolation among the closest calibrated-offline-reference images).

The feature matching module 184 makes a comparison of the runway lines from the real time camera image and the reference image and then provides the error in the translational and rotational coordinates. Then the flow proceeds to block 808. At block 808, the process flows to block 710 in FIG. 7.

Thus, the system and methods described herein implement a program product for improving landing capability for an aircraft at a destination runway. The program-product includes a processor-readable medium (storage medium 120) on which program instructions are embodied. The program instructions are operable, when executed by at least one processor 90 included in the aircraft 50, to cause the aircraft 50 to: compare real-time images of the destination runway 166 with stored calibrated-offline-reference images of the destination runway; select closest calibrated-offline-reference images from the calibrated-offline-reference images for the associated real-time images; evaluate translational differences (Δlat, Δlong, Δalt) and rotational differences (Δψ, Δφ, Δθ) between associated real-time images and selected closest calibrated-offline-reference images; and determine errors in t translational coordinates (lat, long, alt) and rotational coordinates (ψ, φ, θ) provided by a navigation system 95 in the aircraft 50 during the approach based on the evaluated translational coordinates (lat, long, alt) and rotational coordinates (ψ, φ, θ); correct the errors in the translational coordinates and the rotational coordinates; and estimate an improved (Δlat, Δlong, Δalt) and orientation (Δψ, Δφ, Δθ) of the aircraft 50 with respect to the centerline 67 of the destination runway 166 based on the correcting of the errors.

The methods and system described herein permit precision landing at a runway that does not include ground based equipment even if there is low visibility of the runway. Also, methods and system described herein can be implemented in well lit airports that include ground based equipment in order to improve the precision of landings. Since the onboard INS/GPS systems typically have some error, the ground based systems are implemented to enhance the precision of the landings to ensure safety. However, if the aircraft loses communication with the air traffic controller during an approach, then the landing is not as safe due to inherent errors in the INS/GPS system. In such a case, the implementation of methods and system described herein can be used to improve the precision of the landing.

Although specific embodiments have been illustrated and described herein, it will be appreciated by those skilled in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

What is claimed is:

1. A method to improve landing capability for an aircraft, the method comprising:
storing calibrated-offline-reference images of at least one runway in the aircraft;
capturing real-time images of a destination runway during an approach to the destination runway, the destination runway being one of the at least one runway;
comparing the real-time images of the destination runway with the calibrated-offline-reference images of the destination runway to select respective closest calibrated-offline-reference images from the calibrated-offline-reference images for the associated real-time images;
evaluating translational differences and rotational differences between associated real-time images and selected closest calibrated-offline-reference images; and
determining errors in translational coordinates and rotational coordinates provided by a navigation system in the aircraft during the approach based on the evaluated translational differences and rotational differences.

2. The method of claim 1, further comprising:
feeding the translational differences and rotational differences to a Kalman filter;
correcting the determined errors in the translational coordinates and the rotational coordinates based on an output of the Kalman filter; and
estimating an improved distance and orientation of the aircraft with respect to the destination runway based on the correcting.

3. The method of claim 1, wherein capturing the real-time images of the destination runway during the approach comprises capturing a plurality of real-time images in succession with a camera on the aircraft.

4. The method of claim 1, wherein capturing the real-time images of the destination runway during the approach comprises capturing the real-time images of the destination runway with one of a forward looking infra-red camera, a stereo camera, or a combination of the forward looking infra-red camera and the stereo camera.

5. The method of claim 1, wherein storing the calibrated-offline-reference images of the at least one runway comprises:
collecting a plurality of images of the at least one runway with a calibration camera in a hovercraft, the plurality of images being collected from an associated plurality of known geographic locations while the hovercraft is orientated in a known orientation;
associating the plurality of images of the at least one runway with the associated plurality of known geographic locations;
generating a calibrated set of the offline-reference images for an associated one of the at least one runway; and
associating a respective plurality of translational parameters and a respective plurality of rotational parameters with the plurality of images.

6. The method of claim 5, wherein storing calibrated-offline-reference images of at least one runway in the aircraft comprises:
storing a first calibrated set of the offline-reference images for a first runway, the first runway being the destination runway; and
storing a second calibrated set of the offline-reference images for a second runway, the second runway being an alternative-destination runway.

7. The method of claim 5, further comprising:
extracting features from the offline-reference images; and
extracting features from the real-time images of the destination runway.

8. The method of claim 5, further comprising using image interpretation techniques to render a three-dimensional picture of the at least one runway from the offline-reference images.

9. The method of claim 1, further comprising calibrating the offline-reference images of the at least one runway.

10. The method of claim 9, wherein calibrating the offline-reference images of the at least one runway comprises:
positioning a hovercraft in a first known geographic location;
orientating the hovercraft in a first known orientation;
obtaining a first image with a calibration camera in the hovercraft;
determining first translational parameters and first rotational parameters for the first image with reference to a known coordinate and orientation of the one of the at least one runway;
associating the determined first translational parameters and the determined first rotational parameters with the first image;
moving the hovercraft to a second known geographic location;
orientating the hovercraft in a second known orientation;
obtaining a second image with the calibration camera in the hovercraft;
determining second translational parameters and second rotational parameters for the second image with reference to the known coordinate and the orientation of the one of the at least one runway; and
associating the determined second translational parameters and the determined second rotational parameters with the second image.

11. The method of claim 10, wherein moving the hovercraft to the second known geographic location comprises moving the hovercraft to the second known geographic location, the second location being separated from the first known geographic location by less than 500 meters in a latitudinal direction, by less than 500 meters in a longitudinal direction, and by less than 500 meters in a vertical direction.

12. The method of claim 1, wherein storing the calibrated-offline-reference images of the at least one runway in the aircraft, the method further comprising:
loading a database with a calibrated set of the offline-reference images for the destination runway; and
loading the database with translation/rotation coordinates associated with the calibrated set of the offline-reference images.

13. A system to improve landing capability for an aircraft, the system comprising:
a navigation system to provide a geographic location and an orientation of the aircraft;
a real-time camera to capture real-time images of a destination runway during an approach to the destination runway;
a memory storing a database including a calibrated set of offline-reference images of the destination runway and including translation/rotation coordinates associated with the calibrated set of the offline-reference images; and
at least one processor operable to execute software to compare the real-time images of the destination runway with the calibrated set of offline-reference images and to select respective closest calibrated-offline-reference images from the calibrated set of the offline-reference images for the associated real-time images, wherein the at least one processor evaluates translational differences and rotational differences between associated real-time images and selected closest calibrated-offline-reference images.

14. The system of claim 13, wherein the navigation system comprises:
an inertial navigation system to provide information indicative of an orientation of the aircraft; and
a global positioning system receiver to provide information indicative of a known geographic location of the aircraft.

15. The system of claim 13, further comprising a Kalman filter to determine errors in a known geographic location and an orientation of the aircraft based on the translational differences and the rotational differences between the associated real-time images and selected closest calibrated-offline-reference images and to output error corrections to the navigation system.

16. The system of claim 13, wherein the set of calibrated set of offline-reference images of the destination runway includes image features of the destination runway, the system further comprising:
an image extraction module to extract closest calibrated-image features from the calibrated-offline-reference images;
a feature extraction module to extract features from the real-time images; and
a feature matching module to align the extracted calibrated-image features with the extracted features from the real-time images, wherein errors in the geographic location and the orientation provided by the navigation system are determined by the aligning.

17. The system of claim 15, wherein the system further comprises an image-matching module to select a closest calibrated-image from the calibrated-offline-reference images, wherein the closest calibrated-image most closely matches the most recently captured real-time image.

18. The system of claim 13, further comprising a calibration system to collect calibrated sets of offline-reference images of runways and translation/rotation coordinates associated with the calibrated sets of the offline-reference images, the calibration system including:
a hovercraft in which a calibration camera and a navigation system are located.

19. A program product for improving landing capability for an aircraft at a destination runway, the program-product comprising a processor-readable medium on which program instructions are embodied, wherein the program instructions are operable, when executed by at least one programmable processor included in the aircraft, to cause the aircraft to:
compare real-time images of the destination runway with stored calibrated-offline-reference images of the destination runway;
select closest calibrated-offline-reference images from the calibrated-offline-reference images for the associated real-time images;
evaluate translational differences and rotational differences between associated real-time images and selected closest calibrated-offline-reference images; and
determine errors in translational coordinates and rotational coordinates provided by a navigation system in the aircraft during the approach based on the evaluated translational differences and rotational differences.

20. The program product of claim 19, wherein the program instructions are further operable, when executed by at least one programmable processor included in the aircraft, to cause the aircraft to:
correct the errors in the translational coordinates and the rotational coordinates; and
estimate an improved distance and orientation of the aircraft with respect to the destination runway based on the correcting of the errors.
